(19) United States
(12) Patent Application Publication
(10) Pub. No.: US 2024/0378637 A1
(43) Pub. Date: Nov. 14, 2024

(54) Inferring Target Objects for an Attirbution Model Based on Links in Content Items

(71) Applicant: Maplebear Inc. (dba Instacart), San Francisco, CA (US)

(72) Inventors: Vijay Sivasubramaniam, San Francisco, CA (US); Hang Li, British Columbia (CA); Yingshi Zhang, San Jose, CA (US); Senduren Sivakumar, Ontario (CA)

(21) Appl. No.: 18/196,395

(22) Filed: May 11, 2023

(51) Int. Cl. G06Q 30/0242; G06Q 30/0241; G06Q 30/0251

(52) U.S. Cl. CPC G06Q 30/0246; G06Q 30/0253; G06Q 30/0277; G06Q 30/0633

(57) ABSTRACT

An online system receives, from an entity, a content item to be presented to online system users, in which the content item includes a landing page to a third-party website. The system accesses the landing page, identifies a set of items included in it, and determines whether the landing page is configured for performing one or more types of conversions associated with each item. The system matches one or more of the items with one or more target objects based on the determination and associates the matched target object(s) with the content item. The system receives information describing one or more impression events associated with presenting the content item to a user and information describing a conversion associated with a target object associated with the content item performed by the user, applies an attribution model to determine a contribution of the impression event(s) to the conversion, and reports the contribution.

### BACKGROUND

Online systems, such as online advertising systems, may allow entities (e.g., brands or retailers), to create content items (e.g., advertisements) that are presented to users of the online systems. A content item may be associated with an item and include a prompt (e.g., a call to action) to perform an action associated with the item. For example, an advertisement that promotes a product may encourage a user of an online system to whom it is presented to place an order for the product.

Online systems may evaluate the effectiveness of content items at encouraging users to perform actions associated with items with which the content items are associated by determining the contributions of presentations of the content items to subsequent actions associated with the items performed by users presented with the content items. For example, if advertisements promoting a product are presented to a user of an online system who subsequently orders the product, the online system may use an attribution model to determine how much credit to apportion each presentation of an advertisement for its contribution to the placement of the order. However, information identifying items associated with content items may not be provided to online systems (e.g., due to inadvertent omission), making it difficult for the online systems to associate actions performed by users with presentations of the content items and to evaluate the effectiveness of the content items at encouraging the performance of the actions.

### SUMMARY

In accordance with one or more aspects of the disclosure, an online system matches one or more items included in a landing page for a content item with one or more target objects associated with the content item. More specifically, an online system receives, from an entity, a content item to be presented to users of the online system, in which the content item includes a landing page to a third-party website. The online system accesses the landing page and identifies a set of items included in it. The online system determines whether the landing page is configured for performing one or more types of conversions associated with each item, matches one or more of the items with one or more target objects based at least in part on the determination, and associates the matched target object(s) with the content item. The online system receives information describing one or more impression events associated with presenting the content item to a user of the online system, as well as information describing a conversion associated with a target object associated with the content item performed by the user. The online system then applies an attribution model to determine a contribution of the impression event(s) to the conversion and reports the determined contribution.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for matching one or more items included in a landing page for a content item with one or more target objects associated with the content item, in accordance with one or more embodiments.

FIG. 4A illustrates an example of a landing page to a third-party website included in a content item, in accordance with one or more embodiments.

FIG. 4B illustrates an example of items matched with target objects associated with a content item, in accordance with one or more embodiments.

### DETAILED DESCRIPTION

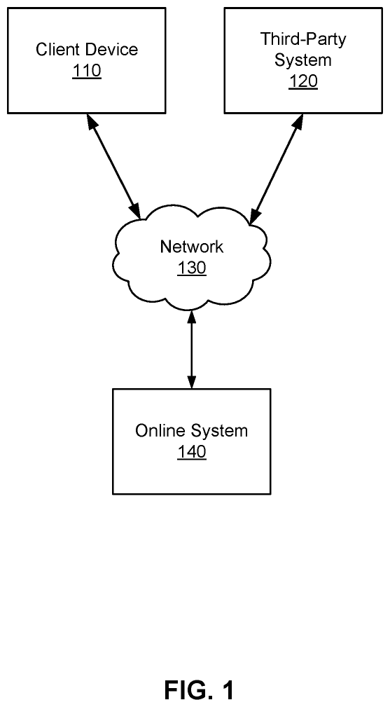

FIG. 1 illustrates an example system environment for an online system 140, such as an online advertising system, in accordance with one or more embodiments. The system environment illustrated in FIG. 1 includes a client device 110, a third-party system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention. While one client device 110 and third-party system 120 are illustrated in FIG. 1, any number of client devices 110 and third-party systems 120 may interact with the online system 140. As such, there may be more than one client device 110 or third-party system 120.

The client device 110 is a computing device through which a user of the client device 110 may interact with the third-party system 120 or the online system 140. The client device 110 may be a personal or mobile computing device, such as a smartphone, a tablet, a laptop computer, or a desktop computer. In some embodiments, the client device 110 executes a client application that uses an application programming interface (API) to communicate with the online system 140.

The client device 110 may receive pieces of content or “content items” from the online system 140 or the third-party system 120 to present to a user of the client device 110. Content items may include advertisements, landing pages, images (e.g., photographs), videos, links, coupons, promotions, recipes, suggestions, notifications, page posts, status updates, check-in events (e.g., at retailer locations), gaming application achievements, or any other suitable types of content. The client device 110 may present content items to a user as the user uses the client device 110 (e.g., to place an order as part of an ordering interface) and may allow the user to interact with the content items (e.g., by clicking on them, expressing a preference for them, sharing them with other users, etc.).

In some embodiments, the client device 110 may present a user interface, which may be part of a client application operating on the client device 110. In such embodiments, the user interface may allow a user to search for and interact with items that are available through the online system 140 or the third-party system 120. Examples of items include: goods, products, services, videos, images, applications, or any other suitable types of objects with which a user may interact. For example, via the user interface, a user may search for items, such as videos, gaming applications, services, etc. and interact with the items by watching videos, installing gaming applications, subscribing to services, etc. The client device 110 also may communicate information to the online system 140 or the third-party system 120 describing impression events or conversions, as further described below.

The third-party system 120 is a computing system operated by a third party, such as an entity (e.g., a retailer or a brand), that interacts with the online system 140. For example, the third-party system 120 may be operated by a retailer that operates a retailer location (e.g., a store, a warehouse, or other building from which items may be acquired, collected, etc.) or by another entity that operates a third-party website (e.g., an online marketplace, a video sharing website, etc. from which items may be ordered, viewed, etc.). In some embodiments, the third-party system 120 also may be an application provider communicating information describing an application for execution by the client device 110 or communicating data to the client device 110 for use by an application executing on the client device 110. The third-party system 120 may store and provide various types of data to the online system 140 or to the client device 110. For example, the third-party system 120 may store one or more web pages and transmit the web page(s) to the client device 110 or to the online system 140. In various embodiments, the third-party system 120 also may provide the online system 140 or the client device 110 with updated data. For example, the third-party system 120 may regularly provide data to the online system 140 indicating which items (e.g., brands, types, etc. of products) are available at a retailer location or via a third-party website and the quantities of those items. In this example, the third-party system 120 also may transmit updated data to the online system 140, such as when items featured on the third-party website have changed, when a price, a sale, or an availability of an item has changed at the retailer location or on the third-party website, etc.

The client device 110, the third-party system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 may be an online advertising system, an online analytics system, an online concierge system, a social networking system, a search engine, an online marketplace, or any other type of online system 140 that may determine the contribution of impression events to conversions. An “impression event,” as used herein, refers to a presentation of a content item to a user. For example, each time a content item is displayed in a display area of a client device 110, it may correspond to an impression event associated with presenting the content item to a user associated with the client device 110. A “conversion,” as used herein, refers to a performance of a desired action by a user with respect to an item. Examples of conversions include: watching a video, downloading digital content, visiting a website or a physical location, acquiring (e.g., ordering or purchasing) a product, adding a product to a shopping list or a shopping cart, subscribing to a service, signing up to receive emails or text messages, etc. The desired action corresponding to a conversion may be specified by an entity associated with an item. For example, if an item is a service offered by an entity, the entity may specify that a conversion associated with the service corresponds to subscribing to the service. An item may be matched with a “target object,” which is an object that is a target of a prompt or a call to action associated with a content item, as further described below, such that a conversion performed with respect to the item may be associated with the target object. For example, if an item corresponding to an image is matched with a target object, a conversion associated with the target object may correspond to clicking on the image, sharing the image, downloading the image, saving the image, etc. Furthermore, a conversion may be performed in response to a call to action associated with a content item presented to a user, in which the content item is associated with a target object (e.g., a content item encouraging users to purchase an item matched with the target object).

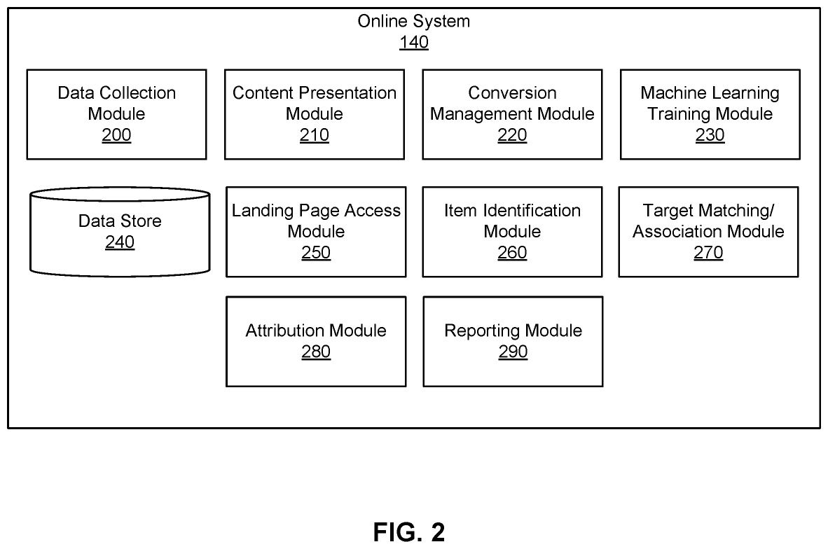

The online system 140 may perform various steps involved in determining the contribution of impression events to conversions. In some embodiments, the online system 140 may receive content items from one or more third-party systems 120 or one or more client devices 110 and present the content items to users of the online system 140. For example, the online system 140 may be an online advertising and analytics system that sends advertisements received from various brands or retailers for display to client devices 110 associated with users using various means (e.g., paid search advertising, social media advertising, display advertising, email advertising, video advertising, etc.). The online system 140 may receive a content item in association with information identifying one or more items associated with the content item, while in other embodiments, the online system 140 may receive a content item without this information. The online system 140 also may receive information describing impression events and conversions from client devices 110 associated with users. In the above example, the online system 140 may track impression events associated with presenting the advertisements to the users and conversions performed by the users (e.g., using cookies or tracking pixels) and determine the contribution of the impression events to the conversions (e.g., using one or more attribution models). Alternatively, the online system 140 may receive information describing impression events and conversions from one or more third-party systems 120 that track this information. The online system 140 also may access landing pages for content items to be presented to users, identify items included in the landing pages, match the items with target objects, and associate the target objects with the content items, as further described below. The online system 140 is described in further detail below with regards to FIG. 2.

FIG. 2 illustrates an example system architecture for an online system 140, such as an online advertising system, in accordance with some embodiments. The system architecture illustrated in FIG. 2 includes a data collection module 200, a content presentation module 210, a conversion management module 220, a machine learning training module 230, a data store 240, a landing page access module 250, an item identification module 260, a target matching/association module 270, an attribution module 280, and a reporting module 290. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

The data collection module 200 collects user data, which is information or data that describe characteristics of a user. User data may include a user's name, address, shopping preferences, favorite items, favorite retailers, stored payment instruments, and demographic information (e.g., age, gender, etc.). The user data also may include default settings established by a user, such as a default retailer/retailer location, payment instrument, delivery location, or delivery timeframe. The data collection module 200 may collect the user data from sensors on the client device 110 or based on a user's interactions with the online system 140.

The data collection module 200 also collects item data, which is information or data that identifies and describes items (e.g., goods, products, services, videos, images, applications, etc.) that are available (e.g., at a retailer location or via a third-party website). The item data may include item identifiers for items that are available and may include quantities of items associated with each item identifier. Additionally, item data may also include attributes of items such as the brands, names, sizes, colors, weights, models/versions, stock keeping units (SKUs), or serial numbers for the items. The item data may further include rules associated with acquiring each item, if they exist. For example, age-restricted items such as alcohol and tobacco are flagged accordingly in the item data. Item data may also include information that is useful for predicting the availability of items (e.g., at retailer locations). For example, for each item-retailer combination (a particular item at a particular retailer location), the item data may include a time that the item was last found, a time that the item was last not found (a search for the item was performed, but the item could not be found), the rate at which the item is found, or the popularity of the item. The data collection module 200 may collect item data from a third-party system 120 or a client device 110.

An item category is a set of items that are a similar type of item. Items in an item category may be considered to be equivalent to each other or may be replacements for each other (e.g., in an order). For example, different brands of sourdough bread may be different items, but these items may be in a “sourdough bread” item category. In some embodiments, item categories may be broader in that the same item category may include item types that are related to a common theme, found in the same department, etc. Furthermore, in various embodiments, an item may be included in multiple categories. For example, a word puzzle gaming application may be included in a “word puzzle gaming application” item category, a “word gaming application” item category, a “puzzle gaming application” item category, a “gaming application” item category, and/or an “application” item category. The item categories may be human-generated and human-populated with items. The item categories also may be generated automatically by the online system 140 (e.g., using a clustering algorithm).

The data collection module 200 also collects entity data, which is information or data that describe characteristics, attributes, or other types of information associated with an entity (e.g., a brand or a retailer). The data collection module 200 may receive the entity data from a client device 110 associated with an entity, a third-party system 120 associated with the entity (e.g., a third-party system 120 operated by a retailer that offers items associated with the entity for purchase), or any other suitable source. The entity data may include a name of an entity, an address associated with the entity, a logo associated with the entity, information describing items (e.g., goods, products, services, videos, images, applications, etc.) associated with the entity, content associated with the entity (e.g., content items received from the entity), campaigns associated with the entity, or any other suitable types of information associated with the entity. In various embodiments, the entity data also may include a catalog of items associated with an entity (e.g., a catalog of products associated with the entity offered for purchase by one or more retailers). A catalog of items may be human-generated and human-populated with items (e.g., based on universal product codes (UPCs) associated with an entity). A catalog of items also may be generated by the data collection module 200 (e.g., by querying data stored in the data store 240 for items associated with an entity).

In various embodiments, the entity data also may include a hierarchical taxonomy into which items associated with an entity may be organized, in which different levels of the hierarchical taxonomy provide different levels of specificity about items included in the levels. In some embodiments, the data collection module 200 may determine a hierarchical taxonomy of items from a catalog of items associated with an entity. In such embodiments, the data collection module 200 may determine the hierarchical taxonomy by applying a trained classification model to the catalog of items to include different items in levels of the hierarchical taxonomy, such that specific items are associated with item categories corresponding to levels within the hierarchical taxonomy. Alternatively, the data collection module 200 may receive a hierarchical taxonomy of items from an entity (e.g., a third-party system 120 associated with a retailer that offers the items for purchase) or any other suitable source.

A hierarchical taxonomy of items associated with an entity may identify an item category and associate one or more specific items with the item category. For example, if an item category identifies “milk,” a hierarchical taxonomy of items may associate identifiers of different milk items (e.g., milk having one or more different attributes) with the item category. Thus, a hierarchical taxonomy of items maintains associations between an item category and specific items associated with an entity matching the item category. Furthermore, different levels of a hierarchical taxonomy of items may identify items with differing levels of specificity based on any suitable attribute or combination of attributes of the items. For example, different levels of a hierarchical taxonomy of items may specify different combinations of attributes of items, such that items in lower levels of the hierarchical taxonomy have a greater number of attributes, corresponding to greater specificity in an item category, while items in higher levels of the hierarchical taxonomy have a fewer number of attributes, corresponding to less specificity in an item category. In various embodiments, higher levels of a hierarchical taxonomy of items may include fewer details about items, such that greater numbers of items are included in higher levels (e.g., higher levels include a greater number of items satisfying a broader item category). Similarly, lower levels of a hierarchical taxonomy of items may include greater details about items, such that fewer numbers of items are included in the lower levels (e.g., lower levels include a fewer number of items satisfying a more specific item category). A hierarchical taxonomy of items may be maintained by the data collection module 200 and stored in the data store 240.

The data collection module 200 also collects content items for presentation to users of the online system 140. The data collection module 200 may receive content items from one or more third-party systems 120 or one or more client devices 110. For example, the data collection module 200 may receive content items from third-party systems 120 operated by various entities (e.g., brands or retailers). As described above, content items may include advertisements, landing pages, images (e.g., photographs), videos, links, coupons, promotions, recipes, suggestions, notifications, page posts, status updates, check-in events (e.g., at retailer locations), gaming application achievements, or any other suitable types of content. For example, the data collection module 200 may receive an advertisement promoting a product from a third-party system 120 operated by a retailer that offers the product for sale.

Additionally, the data collection module 200 collects content data, which is information or data that identifies and describes content items that may be presented to users of the online system 140. The content data may include information describing a type of a content item, one or more target objects associated with the content item, the contents of the content item, information identifying one or more entities associated with the content item, a call to action associated with the content item, a campaign associated with the content item, or any other suitable types of information. For example, the content data may include information indicating that a content item is an advertisement, information describing a product matched with a target object that is promoted by the advertisement, and information identifying a retailer from which the advertisement was received. In this example, the content data also may include information indicating that the advertisement includes a video and a landing page to a third-party website from which the product may be purchased, information indicating that a call to action associated with the advertisement corresponds to placing an order for the product, and a spring 2023 campaign associated with the advertisement.

The content presentation module 210 may select content (e.g., content items or items) for presentation to a user of the online system 140. For example, the content presentation module 210 selects which content items to present to a user while the user is accessing the online system 140. In some embodiments, the content presentation module 210 also may generate and transmit a user interface. For example, if the online system 140 is an online concierge system 140, the content presentation module 210 may generate and transmit an ordering interface for users to order items. In such embodiments, the content presentation module 210 populates the user interface with content with which a user may interact (e.g., items that the user may select for adding to their order).

The content presentation module 210 may select content for presentation to a user based on various factors (e.g., a relevance of the content to the user, a likelihood that the user will interact with the content, an expected value associated with the content, etc.) and present the selected content to the user. For example, the content presentation module 210 may access content items stored in the data store 240, score the content items based on their relevance to a user or based on likelihoods that the user will interact with the content items, and rank the content items based on their scores. In this example, the content presentation module 210 then sends the content items with scores that exceed some threshold (e.g., the top n content items or the p percentile of content items) for display to a client device 110 associated with the user. Alternatively, in the above example, the content presentation module 210 may score the content items based on an expected value associated with each content item, in which the expected value is computed as a product of a bid amount associated with the content item (e.g., a cost-per-click bid) and a probability that the user will interact with the content item (e.g., a predicted click-through rate).

The content presentation module 210 may use a content selection model to score content for presentation to a user. A content selection model is a machine learning model that is trained to score content for presentation to a user based on data for the content (e.g., item data or content data) and user data for the user. For example, the content selection model may be trained to determine a likelihood that a content item is relevant to a user. In some embodiments, the content selection model uses content embeddings describing content and user embeddings describing users to score content. These content embeddings and user embeddings may be generated by separate machine learning models and may be stored in the data store 240.

The content presentation module 210 also receives information describing impression events associated with presenting content items to users of the online system 140. As described above, an impression event refers to a presentation of a content item to a user, such that each time a content item is displayed in a display area of a client device 110 associated with a user may correspond to an impression event associated with presenting the content item to the user. Information describing an impression event may include a time of the impression event, information describing a content item that was presented, information identifying a user of the online system 140 to whom the content item was presented, or any other suitable types of information associated with the impression event. For example, information describing an impression event may include a timestamp indicating a date and time of day at which the impression event occurred and information associated with a content item that was presented (e.g., information describing one or more target objects associated with the content item, a landing page for the content item, an entity associated with the content item, etc.). In this example, information describing the impression event also may include a username or other identifier associated with a user to whom the content item was presented, information describing a client device 110 associated with the user at which the content item was presented (e.g., an operating system of the client device 110), etc. The content presentation module 210 may receive information describing impression events from client devices 110 associated with users of the online system 140 to whom content items were presented or from third-party systems 120 (e.g., third-party systems 120 that presented the content items to the users). Information describing impression events may be stored in the data store 240.

The conversion management module 220 receives information describing conversions associated with target objects performed by users of the online system 140. Information describing a conversion may describe a type of the conversion (e.g., ordering a product, subscribing to a service, etc.), a target object associated with the conversion, a time of the conversion, a user associated with the conversion (e.g., a username or other identifier associated with the user), or any other suitable types of information associated with the conversion. For example, suppose that a conversion corresponds to placing an order for an item matched with a target object. In this example, the conversion management module 220 may receive information indicating that an order for the item was placed, information describing each item included in the order, a time that the order was placed, a user associated with the order, and a third-party website from which the item was ordered. The conversion management module 220 may receive information describing conversions from client devices 110 associated with users of the online system 140 who performed the conversions or from third-party systems 120 (e.g., third-party systems 120 that operate third-party websites or retailer locations at which the conversions were performed). Information describing conversions may be stored in the data store 240.

The machine learning training module 230 trains machine learning models used by the online system 140. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include user data, item data, entity data, or content data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In situations in which the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores user data, item data, entity data, and content data, for use by the online system 140. As an additional example, the data store 240 stores content items including advertisements, landing pages, images (e.g., photographs), videos, links, coupons, promotions, recipes, suggestions, notifications, page posts, status updates, check-in events (e.g., at retailer locations), gaming application achievements, etc. for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

The landing page access module 250 accesses landing pages for content items. A landing page for a content item may be presented in response to receiving an interaction with the content item (e.g., clicking on the content item, clicking on a button included in the content item, etc.). A landing page for a content item may be to a third-party website, such as a brand page or a retail website. For example, if a content item includes a video, a landing page that is presented in response to clicking on the video may be a video sharing website. The landing page access module 250 may access a landing page for a content item periodically (e.g., once a day, once a week, etc.). Alternatively, the landing page access module 250 may access a landing page in response to receiving various types of information. For example, the landing page access module 250 may access a landing page for a content item in response to receiving information from an entity associated with the content item indicating that the landing page has changed. As an additional example, the landing page access module 250 may access a landing page for a content item in response to receiving information from the content presentation module 210 describing an impression event associated with presenting the content item to a user of the online system 140.

The item identification module 260 identifies a set of items included in a landing page. As described above, items may include goods, products, services, videos, images, applications, or any other suitable types of objects with which a user may interact. For example, if a landing page for a content item is a brand page associated with a retailer, the item identification module 260 may identify a set of items included in the landing page corresponding to one or more products offered for sale by the retailer that a user presented with the landing page may purchase, videos promoting the product(s), etc. In embodiments in which the landing page access module 250 accesses a landing page for a content item and the landing page has been updated since the last time the landing page access module 250 accessed it, the item identification module 260 may identify an additional set of items included in the landing page. In some embodiments, the item identification module 260 may store information describing a set of items included in a landing page in the data store 240.

The item identification module 260 also determines, for each item included in a landing page that it identifies, whether the landing page is configured for performing one or more types of conversions associated with the item. The item identification module 260 may make this determination based on information included in the landing page associated with the item, content data describing a content item that includes the landing page, or any other suitable types of information. For example, suppose that a content item includes a landing page to a third-party website and that content data stored in the data store 240 indicates that a call to action associated with the content item corresponds to placing an order. In this example, the item identification module 260 may determine that the landing page is configured for performing a type of conversion corresponding to placing an order for each item included in the landing page that it identifies if the item may be added to a shopping cart. In this example, the item identification module 260 also may determine that the landing page is not configured for performing a type of conversion corresponding to placing an order for each item corresponding to a video if the item may not be added to the shopping cart. In embodiments in which the item identification module 260 identifies an additional set of items included in a landing page, the item identification module 260 may determine, for each additional item included in the landing page, whether the landing page is configured for performing one or more types of conversions associated with the additional item in a manner analogous to that described above. In some embodiments, the item identification module 260 may store information indicating whether a landing page is configured for performing one or more types of conversions associated with each item it identifies in the data store 240.

The target matching/association module 270 matches one or more items included in a landing page for a content item with one or more target objects. As described above, a target object is an object that is a target of a prompt or a call to action associated with a content item. The target matching/association module 270 may match the item(s) with the target object(s) based on whether the item identification module 260 determines that the landing page is configured for performing one or more types of conversions associated with each item. For example, suppose that the item identification module 260 determines that a landing page for a content item is configured for performing a type of conversion associated with five items included in the landing page. In this example, the target matching/association module 270 matches each of these items with a target object, resulting in five item-target object pairs.

The target matching/association module 270 also may match one or more items included in a landing page for a content item with one or more target objects based on additional factors. In some embodiments, once the item identification module 260 determines that a landing page is configured for performing one or more types of conversions associated with one or more items included in the landing page, the target matching/association module 270 may match the item(s) with target object(s) based on a prominence of each item within the landing page. For example, suppose that 20 items included in a landing page for a content item are identified by the item identification module 260 and five of the items are arranged in a section near the top of the landing page, while the other 15 items are arranged in other sections that are further down the landing page. In this example, the target matching/association module 270 may match each of the five items included in the section near the top of the landing page with a target object based on a prominence of each item. In various embodiments, once the item identification module 260 determines that a landing page is configured for performing one or more types of conversions associated with one or more items included in the landing page, the target matching/association module 270 also may match a threshold number or percentage of the item(s) with target object(s). For example, the target matching/association module 270 may match up to a threshold number (e.g., five) or percentage (e.g., 10%) of these items with target objects. In some embodiments, the additional factors described above (e.g., a prominence of each item within a landing page for a content item or a threshold number or percentage of items) may be determined by the target matching/association module 270 or an entity (e.g., an entity from which the content item was received).

The target matching/association module 270 also may match one or more items included in a landing page for a content item with one or more target objects based on a taxonomy of items associated with an entity (e.g., an entity from which the content item was received) or information received from the entity identifying one or more items associated with the content item. For example, suppose that the target matching/association module 270 has matched an item included in a landing page for a content item with a target object, in which the item corresponds to a specific soft drink. In this example, if a hierarchical taxonomy associated with an entity from which the content item was received indicates that the soft drink is included in a “soft drink” item category that includes three additional items corresponding to three other types of soft drinks, the target matching/association module 270 also may match the three additional items with three additional target objects. As an additional example, suppose that the target matching/association module 270 has matched an item included in a landing page for a content item with a target object, in which the item corresponds to a specific adventure gaming application. In this example, if information received from the entity identifies two additional items corresponding to two other adventure gaming applications, the target matching/association module 270 also may match the two additional items with two additional target objects. In embodiments in which the item identification module 260 identifies an additional set of items included in a landing page, the target matching/association module 270 may match one or more of the additional items with one or more additional target objects in a manner analogous to that described above. In some embodiments, the target matching/association module 270 may store information describing one or more items matched with one or more target objects in the data store 240.

Once the target matching/association module 270 matches one or more items included in a landing page for a content item with one or more target objects, the target matching/association module 270 associates the matched target object(s) with the content item. For example, once the target matching/association module 270 matches each of five items included in a landing page for a content item with a corresponding target object, the target matching/association module 270 may associate the five target objects with the content item. In embodiments in which the target matching/association module 270 matches one or more additional items included in a landing page for a content item with one or more additional target objects, the target matching/association module 270 may associate the matched additional target object(s) with the content item in a manner analogous to that described above. In some embodiments, once the target matching/association module 270 associates one or more matched target objects with a content item, information describing the association may be stored in the data store 240. In such embodiments, the information describing the association may be stored in association with a time at which the target object(s) was/were associated with the content item or any other suitable types of information.

The attribution module 280 determines a contribution of one or more impression events associated with presenting a content item to a user of the online system 140 to a conversion associated with a target object performed by the user, in which the target object is associated with the content item. For example, suppose that the content presentation module 210 receives information describing one or more impression events associated with presenting a content item to an online system user, as well as information describing a conversion associated with a target object associated with the content item subsequently performed by the user. In this example, the attribution module 280 may determine a contribution of the impression event(s) to the conversion. In some embodiments, the attribution module 280 may make the determination using a set of rules, such as an attribution model, (e.g., last-touch, single-touch, multi-touch, linear, etc.). For example, the attribution module 280 may apply a multi-touch attribution model that credits all impression events equally for a conversion. As an additional example, the attribution module 280 may apply a last-touch attribution model that apportions 100% of the credit for a conversion to a most recent impression.

Once the attribution module 280 determines a contribution of one or more impression events associated with presenting a content item to a user of the online system 140 to a conversion associated with a target object performed by the user, the reporting module 290 may report the contribution. The reporting module 290 may report the contribution to one or more entities. For example, the reporting module 290 may report a contribution of one or more impression events associated with presenting a content item to a user of the online system 140 to a conversion associated with a target object performed by the user to a retailer from which the content item was received. In the above example, if the target object is matched with an item corresponding to a product, the reporting module 290 also or alternatively may report the contribution to an entity associated with the product (e.g., a manufacturer of the product).

### Matching Items Included in a Landing Page with Target Objects Associated with a Content Item

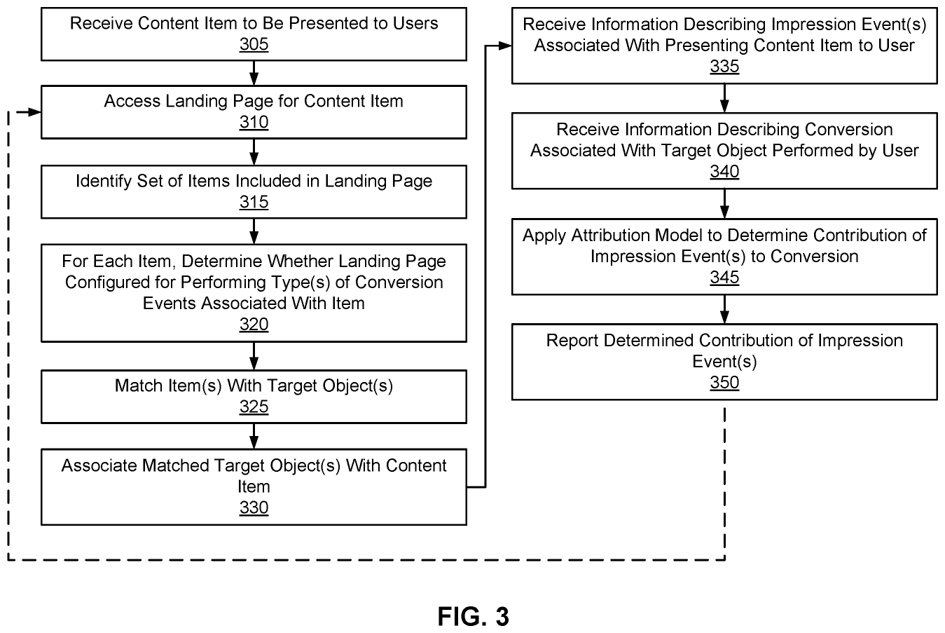

FIG. 3 is a flowchart of a method for matching one or more items included in a landing page for a content item with one or more target objects associated with the content item, in accordance with one or more embodiments. Alternative embodiments may include more, fewer, or different steps from those illustrated in FIG. 3, and the steps may be performed in a different order from that illustrated in FIG. 3. These steps may be performed by an online system (e.g., online system 140), such as an online advertising system. Additionally, each of these steps may be performed automatically by the online system 140 without human intervention.

The online system 140 receives 305 (e.g., via the data collection module 200) a content item to be presented to users of the online system 140, in which the content item includes a landing page to a third-party website. As described above, content items may include advertisements, landing pages, images (e.g., photographs), videos, links, coupons, promotions, recipes, suggestions, notifications, page posts, status updates, check-in events (e.g., at retailer locations), gaming application achievements, or any other suitable types of content. The online system 140 may receive 305 the content item from an entity (e.g., a brand or a retailer). For example, the content item may be an advertisement received 305 from a third-party system 120 operated by a retailer or from a client device 110 associated with the retailer, in which the retailer offers a product promoted by the advertisement for sale and the advertisement includes a landing page to a third-party website for the retailer.

In some embodiments, the online system 140 may receive 305 the content item in association with content data, which is information or data that identifies and describes the content item. The content data may include information describing a type of the content item, one or more target objects associated with the content item, the contents of the content item, information identifying one or more entities associated with the content item (e.g., the entity from which the content item was received 305), a call to action associated with the content item, a campaign associated with the content item, or any other suitable types of information. For example, the content data may include information indicating that the content item is an advertisement, information describing a product matched with a target object that is promoted by the advertisement, and information identifying a retailer from which the advertisement was received 305. In this example, the content data also may include information indicating that the advertisement includes a video and the landing page to the third-party website from which the product may be purchased, information indicating that a call to action associated with the advertisement corresponds to placing an order for the product, and a spring 2023 campaign associated with the advertisement.

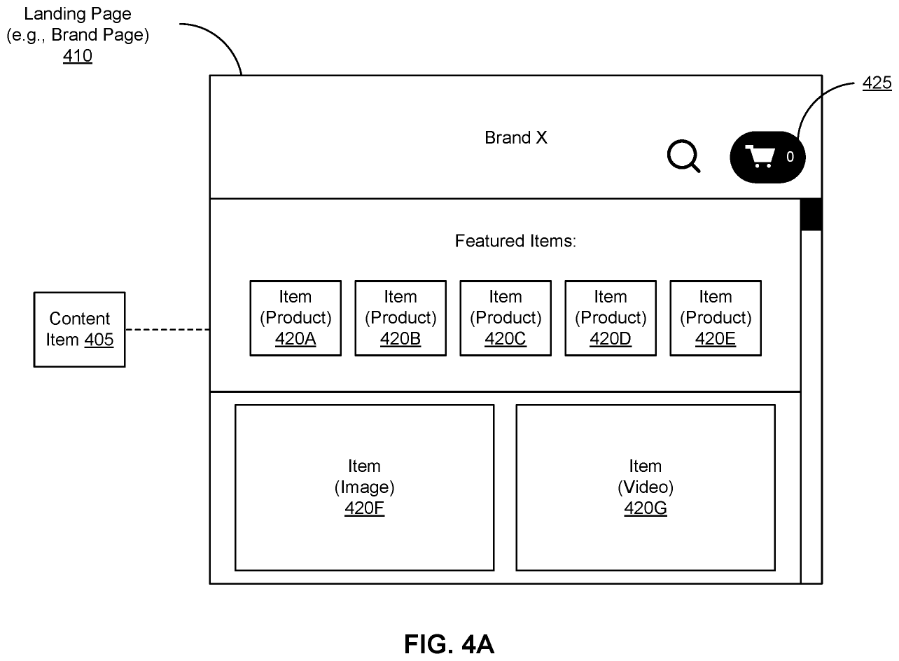

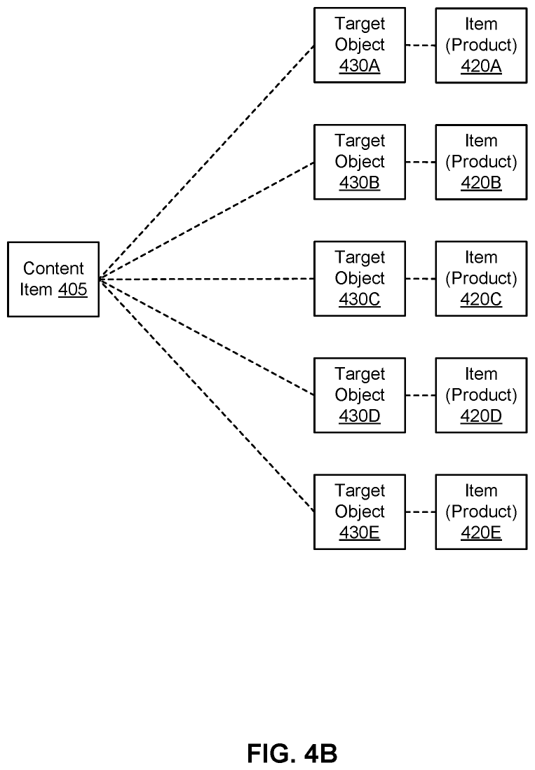

The online system 140 then accesses 310 (e.g., using the landing page access module 250) the landing page for the content item. The landing page for the content item may be presented in response to receiving an interaction with the content item (e.g., clicking on the content item, clicking on a button included in the content item, etc.). As described above, the landing page for the content item is to a third-party website, such as a brand page or a retail website. For example, as shown in FIG. 4A, which illustrates an example of a landing page 410 to a third-party website included in a content item 405, in accordance with one or more embodiments, the landing page 410 may correspond to a brand page for Brand X that is presented in response to clicking on the content item 405.

Referring back to FIG. 3, the online system 140 identifies 315 (e.g., using the item identification module 260) a set of items included in the landing page 410. As described above, items may include goods, products, services, videos, images, applications, or any other suitable types of objects with which a user may interact. For example, as shown in FIG. 4A, the online system 140 may identify 315 the set of items 420 included in the landing page 410, in which the set of items 420 include five products 420A-E offered for sale that a user presented with the landing page 410 may purchase, as well as an image 420F and a video 420G promoting the products. In some embodiments, the online system 140 may store information describing the set of items 420 included in the landing page 410 (e.g., in the data store 240).

Referring again to FIG. 3, the online system 140 also determines 320 (e.g., using the item identification module 260) for each item 420 included in the landing page 410 that it identifies 315, whether the landing page 410 is configured for performing one or more types of conversions associated with the item 420. As described above, a conversion refers to a performance of a desired action by a user with respect to an item 420 (e.g., watching a video, downloading digital content, visiting a website or a physical location, acquiring (e.g., ordering or purchasing) a product, adding a product to a shopping list or a shopping cart, subscribing to a service, signing up to receive emails or text messages, etc.). Furthermore, as also described above, the desired action corresponding to a conversion may be specified by an entity associated with the item 420 (e.g., the entity from which the content item 405 was received 305). For example, if an item 420 is a service offered by an entity, the entity may specify that a conversion associated with the service corresponds to subscribing to the service.

The online system 140 may determine 320 whether the landing page 410 is configured for performing the type(s) of conversions associated with each identified item 420 based on information included in the landing page 410 associated with the item 420, content data describing the content item 405, or any other suitable types of information. For example, suppose that content data (e.g., stored in the data store 240) indicates that a call to action associated with the content item 405 corresponds to placing an order. As shown in FIG. 4A, the online system 140 may determine 320 that the landing page 410 is configured for performing a type of conversion corresponding to placing an order for each item 420 corresponding to a product if the item 420 may be added to a shopping cart 425. Continuing with this example, the online system 140 also may determine 320 that the landing page 410 is not configured for performing a type of conversion corresponding to placing an order for the items 420F-G corresponding to the image and the video if the items 420F-G may not be added to the shopping cart 425. In some embodiments, the online system 140 may store information indicating whether the landing page 410 is configured for performing the type(s) of conversions associated with each item 420 it identifies 315 (e.g., in the data store 240).

Referring back to FIG. 3, the online system 140 matches 325 (e.g., using the target matching/association module 270) one or more items 420 included in the landing page 410 for the content item 405 with one or more target objects. As described above, a target object is an object that is a target of a prompt or a call to action associated with a content item 405. The online system 140 may match 325 the item(s) 420 with the target object(s) based on whether the online system 140 determines 320 that the landing page 410 is configured for performing the type(s) of conversions associated with each item 420. For example, as shown in FIG. 4A, suppose that the online system 140 determines 320 that the landing page 410 for the content item 405 is configured for performing a type of conversion associated with five items 420A-E included in the landing page 410 corresponding to placing an order for each item 420A-E. In this example, the online system 140 matches 325 each of these items 420A-E with a target object, resulting in five item-target object pairs, as shown in FIG. 4B, which illustrates an example of items 420 matched 325 with target objects 430 associated with a content item 405, in accordance with one or more embodiments.

The online system 140 also may match 325 the item(s) 420 included in the landing page 410 for the content item 405 with the target object(s) 430 based on additional factors. In some embodiments, once the online system 140 determines 320 that the landing page 410 is configured for performing the type(s) of conversions associated with the item(s) 420, the online system 140 may match 325 the item(s) 420 with the target object(s) 430 based on a prominence of each item 420 within the landing page 410 for the content item 405. For example, suppose that 20 items 420 included in the landing page 410 for the content item 405 are identified 315 by the online system 140 and five of the items 420 are arranged in a section near the top of the landing page 410, while the other 15 items 420 are arranged in other sections that are further down the landing page 410. In this example, the online system 140 may match 325 each of the five items 420 included in the section near the top of the landing page 410 with a target object 430 based on a prominence of each item 420. In various embodiments, once the online system 140 determines 320 that the landing page 410 is configured for performing the type(s) of conversions associated with the item(s) 420, the online system 140 also may match 325 a threshold number or percentage of the item(s) 420 with the target object(s) 430. For example, the online system 140 may match 325 up to a threshold number (e.g., five) or percentage (e.g., 10%) of these items 420 with target objects 430. In some embodiments, the additional factors described above (e.g., the prominence of each item 420 within the landing page 410 or the threshold number or percentage of items 420) may be determined by the online system 140 or an entity (e.g., the entity from which the content item 405 was received 305).

The online system 140 also may match 325 the item(s) 420 included in the landing page 410 for the content item 405 with the target object(s) 430 based on a taxonomy of items 420 associated with an entity (e.g., the entity from which the content item 405 was received 305) or information received from the entity identifying one or more items 420 associated with the content item 405. For example, suppose that the online system 140 has matched 325 an item 420 included in the landing page 410 for the content item 405 with a target object 430, in which the item 420 corresponds to a specific soft drink. In this example, if a hierarchical taxonomy associated with the entity from which the content item 405 was received 305 indicates that the soft drink is included in a “soft drink” item category that includes three additional items 420 corresponding to three other types of soft drinks, the online system 140 also may match 325 the three additional items 420 with three additional target objects 430. As an additional example, suppose that the online system 140 has matched 325 an item 420 included in the landing page 410 for the content item 405 with a target object 430, in which the item 420 corresponds to a specific adventure gaming application. In this example, if information received from the entity identifies two additional items 420 corresponding to two other adventure gaming applications, the online system 140 also may match 325 the two additional items 420 with two additional target objects 430. In some embodiments, the online system 140 may store information describing the item(s) 420 matched 325 with the target object(s) 430 (e.g., in the data store 240).

Referring back to FIG. 3, once the online system 140 matches 325 the item(s) 420 included in the landing page 410 for the content item 405 with one or more target objects 430, the online system 140 associates 330 (e.g., using the target matching/association module 270) the matched target object(s) 430 with the content item 405. For example, as shown in FIG. 4B, once the online system 140 matches 325 each of the five items 420A-E with its corresponding target object 430A-E, the online system 140 may associate 330 the five target objects 430A-E with the content item 405. In some embodiments, once the online system 140 associates 330 the matched target object(s) 430 with the content item 405, information describing the association may be stored (e.g., in the data store 240). In such embodiments, the information describing the association may be stored in association with a time at which the target object(s) 430 was/were associated 330 with the content item 405 or any other suitable types of information.

Referring once more to FIG. 3, the online system 140 then receives 335 (e.g., via the content presentation module 210) information describing one or more impression events associated with presenting the content item 405 to a user of the online system 140. As described above, an impression event refers to a presentation of a content item 405 to a user, such that each time the content item 405 is displayed in a display area of a client device 110 associated with the user may correspond to an impression event associated with presenting the content item 405 to the user. Information describing an impression event may include a time of the impression event, information describing the content item 405 that was presented, information identifying the user of the online system 140 to whom the content item 405 was presented, or any other suitable types of information associated with the impression event. For example, information describing an impression event may include a timestamp indicating a date and time of day at which the impression event occurred and information associated with the content item 405 that was presented (e.g., information identifying one or more target objects 430 associated 330 with the content item 405, the landing page 410 for the content item 405, the entity associated with the content item 405, etc.). In this example, information describing the impression event also may include a username or other identifier associated with the user, information describing a client device 110 associated with the user at which the content item 405 was presented (e.g., an operating system of the client device 110), etc. The online system 140 may receive 335 the information describing the impression event(s) from a client device 110 associated with the user of the online system 140 to whom the content item 405 was presented or from a third-party system 120 (e.g., a third-party system 120 that presented the content item 405 to the user). The online system 140 may store the information describing the impression event(s) (e.g., in the data store 240).

The online system 140 also receives 340 (e.g., using the conversion management module 220) information describing a conversion associated with a target object 430 associated 330 with the content item 405 performed by the user. For example, the online system 140 receives 340 information describing a conversion performed with respect to an item 420 matched 325 with the target object 430. As described above, a conversion may be performed by the user in response to a call to action associated with the content item 405 presented to the user, in which the content item 405 is associated 330 with the target object 430 (e.g., a content item 405 encouraging users to purchase an item 420 matched 325 with the target object 430). The information describing the conversion may describe a type of the conversion (e.g., ordering a product, subscribing to a service, etc.), the target object 430 associated with the conversion, a time of the conversion, the user associated with the conversion (e.g., a username or other identifier associated with the user), or any other suitable types of information associated with the conversion. For example, suppose that the conversion corresponds to placing an order for an item 420 matched 325 with the target object 430. In this example, the online system 140 may receive 340 information indicating that an order for the item 420 was placed, information describing each item 420 included in the order, a time that the order was placed, the user associated with the order, and a third-party website from which the item 420 was ordered. The online system 140 may receive 340 the information describing the conversion from a client device 110 associated with the user of the online system 140 who performed the conversion or from a third-party system 120 (e.g., a third-party system 120 that operates the third-party website at which the conversion was performed). The online system 140 may store the information describing the conversion (e.g., in the data store 240).

The online system 140 then determines (e.g., using the attribution module 280) a contribution of the impression event(s) associated with presenting the content item 405 to the user of the online system 140 to the conversion associated with the target object 430 performed by the user. For example, suppose that the online system 140 receives 335, 340 information describing one or more impression events associated with presenting the content item 405 to the online system user, as well as the information describing the conversion associated with the target object 430 associated 330 with the content item 405 subsequently performed by the user. In this example, the online system 140 may determine a contribution of the impression event(s) to the conversion. In some embodiments, the online system 140 may make the determination using a set of rules, such as an attribution model, (e.g., last-touch, single-touch, multi-touch, linear, etc.). In such embodiments, the online system 140 may apply 345 the attribution model to determine the contribution of the impression event(s) to the conversion. For example, the online system 140 may apply 345 a multi-touch attribution model that credits the impression event(s) equally for the conversion. As an additional example, the online system 140 may apply 345 a last-touch attribution model that apportions 100% of the credit for the conversion to a most recent impression.

Once the online system 140 determines the contribution of the impression event(s) associated with presenting the content item 405 to the user of the online system 140 to the conversion associated with the target object 430 performed by the user, the online system 140 may report 350 (e.g., using the reporting module 290) the contribution. The online system 140 may report 350 the contribution to one or more entities. For example, the online system 140 may report 350 the contribution to a retailer from which the content item 405 was received 305. In the above example, if the content item 405 is associated 330 with a target object 430 matched 325 with an item 420 corresponding to a product, the online system 140 also or alternatively may report 350 the contribution to an entity associated with the product (e.g., a manufacturer of the product).

In some embodiments, the online system 140 may repeat some of the steps described above (e.g., by proceeding back to the accessing 310 the landing page 410 for the content item 405 step, etc.). In such embodiments, the online system 140 may access 310 the landing page 410 for the content item 405 periodically (e.g., once a day, once a week, etc.). Alternatively, the online system 140 may access 310 the landing page 410 in response to receiving various types of information. For example, the online system 140 may access 310 the landing page 410 for the content item 405 in response to receiving information from an entity associated with the content item 405 indicating that the landing page 410 has changed. As an additional example, the online system 140 may access 310 the landing page 410 for the content item 405 in response to receiving 335 information describing an additional impression event associated with presenting the content item 405 to a user of the online system 140.

In embodiments in which the online system 140 repeats some of the steps described above, the online system 140 may do so in a manner analogous to that described above. For example, if the online system 140 accesses 310 the landing page 410 for the content item 405 and the landing page 410 has been updated since the last time the online system 140 accessed 310 it, the online system 140 may identify 315 an additional set of items 420 included in the landing page 410. In this example, responsive to identifying 315 the additional set of items 420, the online system 140 may then determine 320, for each additional item 420, whether the landing page 410 is configured for performing the one or more types of conversions, match 325 one or more of the additional items 420 with one or more additional target objects 430 based on the determination, and associate 330 the matched additional target object(s) 430 with the content item 405. Continuing with this example, the online system 140 may then receive 335 information describing one or more additional impression events associated with presenting the content item 405 to a user of the online system 140 and receive 340 information describing an additional conversion associated with an additional target object 430 associated 330 with the content item 405 performed by the user. In the above example, the online system 140 may then apply 345 the attribution model to determine an additional contribution of the additional impression event(s) to the additional conversion and report 350 the additional contribution.

Furthermore, in embodiments in which the online system 140 repeats some of the steps described above, the steps may be performed in a different order than that described above. For example, suppose that the online system 140 accesses 310 the landing page 410 for the content item 405 and identifies 315 an additional set of items 420 included in the landing page 410. In this example, the online system 140 may then receive 335 information describing one or more additional impression events associated with presenting the content item 405 to a user of the online system 140 and then perform the determining 320, matching 325, and associating 330 steps described above with respect to the additional item(s) 420 and additional target object(s) 430. Continuing with this example, the online system 140 may then receive 340 information describing an additional conversion associated 330 with an additional target object 430 associated 330 with the content item 405 performed by the user, apply 345 the attribution model to determine an additional contribution of the additional impression event(s) to the additional conversion, and report 350 the additional contribution.

### Additional Considerations

The foregoing description of the embodiments has been presented for the purpose of illustration; many modifications and variations are possible while remaining within the principles and teachings of the above description. Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, from an entity, a content item to be presented to users of an online system,
wherein the content item includes a landing page to a third-party website;
accessing the landing page for the content item;
identifying a set of items included in the landing page;
determining, for each item of the set of items, whether the landing page is configured for performing one or more types of conversions associated with a corresponding item;
matching one or more items of the set of items with one or more target objects based at least in part on whether the landing page is configured for performing the one or more types of conversions associated with the corresponding item;
associating the matched one or more target objects with the content item;
receiving information describing one or more impression events associated with presenting the content item to a user of the online system;
receiving information describing a conversion associated with a target object of the one or more target objects performed by the user;
applying an attribution model to determine a contribution of the one or more impression events to the conversion; and
reporting the determined contribution of the one or more impression events.

2. The method of claim 1, wherein the one or more types of conversions comprise one or more of: acquiring the corresponding item, adding the corresponding item to a shopping cart, or adding the corresponding item to a shopping list.

3. The method of claim 1, wherein matching the one or more items of the set of items with the one or more target objects is further based at least in part on a prominence of each item of the set of items within the landing page for the content item, wherein the prominence of each item is determined by one or more of: the entity or the online system.

4. The method of claim 1, wherein matching the one or more items of the set of items with the one or more target objects is further based at least in part on one or more of: a threshold percentage of the set of items included in the landing page or a threshold number of the set of items included in the landing page.

5. The method of claim 1, wherein matching the one or more items of the set of items with the one or more target objects is further based at least in part on one or more of: a taxonomy of items associated with the entity or information received from the entity identifying an item of the one or more items associated with the content item.

6. The method of claim 1, further comprising:
accessing the landing page for the content item; and
identifying a set of additional items included in the landing page.

7. The method of claim 6, further comprising:
receiving information describing one or more additional impression events associated with presenting the content item to the user of the online system;
determining, for each additional item of the set of additional items, whether the landing page is configured for performing the one or more types of conversions associated with a corresponding additional item;
matching one or more additional items of the set of additional items with one or more additional target objects based at least in part on whether the landing page is configured for performing the one or more types of conversions associated with the corresponding additional item;
associating the matched one or more additional target objects with the content item;
receiving information describing an additional conversion associated with an additional target object of the one or more additional target objects performed by the user;
applying the attribution model to determine an additional contribution of the one or more additional impression events to the additional conversion; and
reporting the determined additional contribution of the one or more additional impression events.

8. The method of claim 6, further comprising:
responsive to identifying the set of additional items included in the landing page, determining, for each additional item of the set of additional items, whether the landing page is configured for performing the one or more types of conversions associated with a corresponding additional item;
matching one or more additional items of the set of additional items with one or more additional target objects based at least in part on whether the landing page is configured for performing the one or more types of conversions associated with the corresponding additional item; and
associating the matched one or more additional target objects with the content item.

9. The method of claim 8, further comprising:
receiving information describing one or more additional impression events associated with presenting the content item to the user of the online system;
receiving information describing an additional conversion associated with an additional target object of the one or more additional target objects performed by the user;
applying the attribution model to determine an additional contribution of the one or more additional impression events to the additional conversion; and
reporting the determined contribution of the one or more additional impression events.

10. The method of claim 1, wherein the content item is received without information identifying the one or more items matched with the one or more target objects.

11. A computer program product comprising a non-transitory computer-readable storage medium having instructions encoded thereon that, when executed by a processor, cause the processor to perform steps comprising:
receiving, from an entity, a content item to be presented to users of an online system, wherein the content item includes a landing page to a third-party website;
accessing the landing page for the content item;
identifying a set of items included in the landing page;
determining, for each item of the set of items, whether the landing page is configured for performing one or more types of conversions associated with a corresponding item;
matching one or more items of the set of items with one or more target objects based at least in part on whether the landing page is configured for performing the one or more types of conversions associated with the corresponding item;
associating the matched one or more target objects with the content item;
receiving information describing one or more impression events associated with presenting the content item to a user of the online system;
receiving information describing a conversion associated with a target object of the one or more target objects performed by the user;
applying an attribution model to determine a contribution of the one or more impression events to the conversion; and
reporting the determined contribution of the one or more impression events.

12. The computer program product of claim 11, wherein the one or more types of conversions comprise one or more of: acquiring the corresponding item, adding the corresponding item to a shopping cart, or adding the corresponding item to a shopping list.

13. The computer program product of claim 11, wherein matching the one or more items of the set of items with the one or more target objects is further based at least in part on a prominence of each item of the set of items within the landing page for the content item, wherein the prominence of each item is determined by one or more of: the entity or the online system.

14. The computer program product of claim 11, wherein matching the one or more items of the set of items with the one or more target objects is further based at least in part on one or more of: a threshold percentage of the set of items included in the landing page or a threshold number of the set of items included in the landing page.

15. The computer program product of claim 11, wherein matching the one or more items of the set of items with the one or more target objects is further based at least in part on one or more of: a taxonomy of items associated with the entity or information received from the entity identifying an item of the one or more items associated with the content item.

16. The computer program product of claim 11, wherein the non-transitory computer-readable storage medium further has instructions encoded thereon that, when executed by the processor, cause the processor to perform steps comprising:
accessing the landing page for the content item; and
identifying a set of additional items included in the landing page.

17. The computer program product of claim 16, wherein the non-transitory computer-readable storage medium further has instructions encoded thereon that, when executed by the processor, cause the processor to perform steps comprising:
receiving information describing one or more additional impression events associated with presenting the content item to the user of the online system;
determining, for each additional item of the set of additional items, whether the landing page is configured for performing the one or more types of conversions associated with a corresponding additional item;
matching one or more additional items of the set of additional items with one or more additional target objects based at least in part on whether the landing page is configured for performing the one or more types of conversions associated with the corresponding additional item;
associating the matched one or more additional target objects with the content item;
receiving information describing an additional conversion associated with an additional target object of the one or more additional target objects performed by the user;
applying the attribution model to determine an additional contribution of the one or more additional impression events to the additional conversion; and
reporting the determined additional contribution of the one or more additional impression events.

18. The computer program product of claim 16, wherein the non-transitory computer-readable storage medium further has instructions encoded thereon that, when executed by the processor, cause the processor to perform steps comprising:
responsive to identifying the set of additional items included in the landing page, determining, for each additional item of the set of additional items, whether the landing page is configured for performing the one or more types of conversions associated with a corresponding additional item;
matching one or more additional items of the set of additional items with one or more additional target objects based at least in part on whether the landing page is configured for performing the one or more types of conversions associated with the corresponding additional item; and
associating the matched one or more additional target objects with the content item.

19. The computer program product of claim 18, wherein the non-transitory computer-readable storage medium further has instructions encoded thereon that, when executed by the processor, cause the processor to perform steps comprising:
receiving information describing one or more additional impression events associated with presenting the content item to the user of the online system;
receiving information describing an additional conversion associated with an additional target object of the one or more additional target objects performed by the user;
applying the attribution model to determine an additional contribution of the one or more additional impression events to the additional conversion; and
reporting the determined contribution of the one or more additional impression events.

20. A computer system comprising:
a processor; and
a non-transitory computer-readable storage medium storing instructions that, when executed by the processor, perform actions comprising:
receiving, from an entity, a content item to be presented to users of an online system, wherein the content item includes a landing page to a third-party website;
accessing the landing page for the content item;
identifying a set of items included in the landing page;
determining, for each item of the set of items, whether the landing page is configured for performing one or more types of conversions associated with a corresponding item;
matching one or more items of the set of items with one or more target objects based at least in part on whether the landing page is configured for performing the one or more types of conversions associated with the corresponding item;
associating the matched one or more target objects with the content item;
receiving information describing one or more impression events associated with presenting the content item to a user of the online system;
receiving information describing a conversion associated with a target object of the one or more target objects performed by the user;
applying an attribution model to determine a contribution of the one or more impression events to the conversion; and
reporting the determined contribution of the one or more impression events.
